(19) United States
(12) Patent Application Publication
(10) Pub. No.: US 2025/0268144 A1
(43) Pub. Date: Aug. 28, 2025

(54) METHOD AND SYSTEM FOR PLANNING A SWATH

(71) Applicant: DEERE & COMPANY, MOLINE, IL (US)

(72) Inventors: STEFAN BROCKE, Mannheim (DE); FLORIAN SCHOTT, Einhausen (DE)

(21) Appl. No.: 19/049,034

(22) Filed: Feb. 10, 2025

(30) Foreign Application Priority Data
Feb. 27, 2024 (EP) 24159915.8

(51) Int. Cl. A01D 80/00; A01B 69/04

(52) U.S. Cl. CPC A01D 80/00; A01B 69/008

(57) ABSTRACT

A method for planning a swath which is created by a rake by raking together a crop mown on an agricultural field, includes determining via a control unit planning data of the swath as a function of at least one of the following planning parameters: field data representing at least one characteristic of the mown agricultural field, a type of the crop, a type of a planned rake, a type of a planned recovery machine for recovering the created swath, and a cutting length of the swath material processed during a recovery.

### CROSS-REFERENCE TO RELATED APPLICATIONS

This application claims priority to European Patent Application No. 24159915.8, filed Feb. 27, 2024, which is hereby incorporated by reference.

### FIELD OF THE DISCLOSURE

The disclosure relates to a method and a system for planning a swath which is created by a rake by raking together a crop mown on an agricultural field.

### BACKGROUND

In agriculture, it is known to rake mown grass together into swaths and then collect the swaths with a recovery machine, e.g., a loader wagon, and transport them to a storage location. The stored grass is usually used in the form of silage as feed.

### SUMMARY

Efficient production of the feed is important here.

Therefore, the object of the present disclosure is to improve the efficiency of the processing of a mown crop.

This object is achieved by a method having the characteristics of one or more of the embodiments disclosed herein and a system having the characteristics of one or more of the embodiments disclosed herein.

Further advantageous embodiments of the disclosure can be found in the one or more embodiments disclosed herein.

According to an embodiment, a method for planning a swath which is created by a rake by raking together a crop mown on an agricultural field is proposed. To plan the swath to be created, planning data are determined as a function of one or more planning parameters. As planning parameters, at least one of the following parameters is provided:
Field data representing at least one characteristic of the mown agricultural field.
A type of the crop, e.g., grass or silage, hay, straw, alfalfa, rapeseed.
A type of a planned rake for the creation of the swath. The different types of rake can refer to different raking technologies (e.g. comb rake, rotary rake, belt rake, front rake, rear rake, middle rake, side rake, number of raking drums or raking rotors) or to different performance characteristics within the same raking technology, e.g. different raking working widths.
A type of a planned recovery machine for recovering the created swath. The different types of recovery machine can refer to different machine functions (e.g., forage harvester, baler, loader wagon or silage wagon) or to different performance characteristics within the same machine function. The recovery machine can be a single machine or a combination of several machines (e.g., forage harvester and loader wagon).
A cutting length of the swath material processed during a recovery. For example, this is a length adjustment for the swath material set on the recovery machine.

Taking into account at least one of the aforementioned planning parameters, planning data can be determined which enable a planned target dimensioning of a swath and thus an optimized swath size. This facilitates a structured approach and consequently improves efficiency when creating a swath or several swaths. For example, the planning data can help to improve the efficiency of an autonomously driving agricultural utility vehicle with a rake (hereinafter referred to as rake vehicle). In other words, the planning data can increase the degree of automation in the creation of swaths. If the rake vehicle is controlled by a driver, the planning data can support the vehicle driver in making decisions for efficient field work.

The planning data are for example planned swath-related variables, for example a geoposition or relative position of the swath on the agricultural field, a swath radius for a curved swath path, a swath length, a swath width or placement width of the swath material or data for a headland on the agricultural field.

The content of this planning data has a relevant influence on the efficiency of creating the swath and its recovery on the one hand and can be implemented precisely when the rake vehicle is deployed on the other. Planning data can be viewed as optimized variables as a function of at least one planning parameter. For example, the geoposition of the swath can be optimized as a function of a field topology of the mown agricultural field and the swath radius and the swatch width can be optimized as a function of specific vehicle data of the recovery vehicle.

For example, the field data contain a field topology and/or field boundaries and/or a field yield (e.g., in kg/m²) of the mown agricultural field. The content of this field data supports an exact knowledge of the properties of the mown agricultural field, which enables correspondingly more precise swath planning.

The field yield of the mown agricultural field can, for example, be recorded by a drone using data technology. Alternatively or additionally, a suitable sensor can be arranged on the mowing machine for mowing the crop, which records the field yield using data technology.

In an embodiment, the planning data are determined as a function of provided characteristic recovery data of the planned recovery machine. The characteristic recovery data contain recovery-related information on the recovery machine planned for the swath recovery. For example, a recovery capacity (e.g., in kg/m) can be extracted or derived from the characteristic recovery data, which is relevant information for adapting and optimizing the planned swath with regard to the selected or planned recovery machine.

The characteristic recovery data can be considered as specific data for a known type of recovery machine and for a known type of crop. For example, they will be made available in a database or data center for data retrieval. The characteristic recovery data may be provided, for example, as a characteristic curve or a data table.

In an embodiment, the characteristic recovery data are generated as a function of at least one of the aforementioned planning parameters and can then be provided. This efficiently supports a planned, optimized target dimensioning of the swath or swaths.

For example, the characteristic recovery data represent a ratio between a recovery capacity (e.g. in kg/m) and a recovery speed (e.g. in kg/h) of the recovery machine. This makes it easy, in terms of the method, to take economic criteria such as the time required for recovering the crop as well as quality criteria for the crop into account when determining the planning data.

An optimum recovery capacity can be determined from the characteristic recovery data. For example, the optimum recovery capacity can be considered as a recovery capacity which is estimated to be the most advantageous recovery capacity of the recovery machine, taking into account specific criteria (e.g., economy, quality).

An ideal size of the planned swath can be derived from the optimum recovery capacity by equating the optimum recovery capacity with the planned size of the swath or swath thickness. The swath thickness can be defined as the mass of the swath material per unit length (e.g., kg/m).

For example, the optimum recovery capacity corresponds to a recovery capacity of the recovery machine at a maximum recovery speed. The maximum recovery speed corresponds to a maximum material flow speed, i.e., a maximum mass of swath material is recovered per unit of time. This supports economy and efficiency when recovering the swath or swaths.

A defined work strategy for creating the swath can be taken into account when determining the planning data. The work strategy is defined as a function of at least one planning parameter and/or the planned recovery capacity and/or the type of the planned rake. The work strategy can therefore be defined in terms of the most efficient deployment of the planned rake, so that the planning data also additionally support the desired efficient processing of the mown crop.

Advantageously, the work strategy can also be defined as a function of an ideal field working width within the mown agricultural field. The ideal field working width is determined as a function of the optimum recovery capacity (i.e., also of the ideal swath thickness) and/or the field yield. The ideal field working width extends within the mown agricultural field transversely to a track of the rake. The extension is dimensioned in such a way that the quantity or mass of the mown crop contained in this extension (e.g., per meter along the swath length) is exactly sufficient for the planned swath or for the determined optimum recovery capacity or determined ideal swath thickness. This further supports the generation of an efficient work strategy for the rake, taking into account available field and/or technical data.

For example, the ideal field working width can also represent an ideal raking working width of the rake (based on a single run of the rake). In practice, the available raking working widths of the planned rake often deviate from this ideal raking working width. This deviation can be compensated for within the work strategy, e.g., by increasing the number of runs or tracks of the rake with the available raking working width.

For example, the work strategy contains at least one working variable for creating the swath. The working variable is, for example, a planned number of tracks of the rake or an agricultural utility vehicle coupled to it (e.g., a tractor or hauler) in order to create the planned swath. In another variant, the working variable represents a planned field working width within the mown agricultural field for the creation of the swath. The planned field working width can be determined as a function of the ideal field working width. The planned field working width can correspond to at least the single raking working width and for example to a (particularly integer) multiple of the raking working width. In addition, the planned field working width corresponds for example to the aforementioned planned number of tracks multiplied by the planned raking working width of the rake.

Analogously to the planned number of tracks and the planned field working width, the planned raking working width can also be used as a working variable.

The defined work strategy can include precise planning for working efficiently with the working variable(s). This supports a correspondingly precise determination of the planning data.

The planned number of tracks of the rake for creating the swath can be driven with one utility vehicle in succession or with several simultaneously active utility vehicles.

Another advantage is that a maximum swath width and maximum placement width of the swath are taken into account to determine the planning data, wherein the maximum swath width is defined as a function of the type of the planned rake and/or the type of the planned recovery machine. This means that additional technical data are taken into account to support the precision of the planning data.

The disclosure further relates to a system for planning a swath, comprising a rake for creating the swath by raking together a crop mown on an agricultural field and comprising a control unit (e.g., a controller including a processor and memory) for carrying out the method of one or more embodiments disclosed herein.

The system according to the disclosure has the above-described advantages of the method according to the disclosure. The control unit can contain suitable algorithms for determining the planning data. The system makes it possible to provide planning data for one or more swaths, which are geared toward precise and efficient creation and recovery of the swaths. This supports high-quality feed production (e.g. silage). The planning data for optimized creation of the swath reduce the workload of the vehicle driver of an agricultural utility vehicle coupled to the rake during the deployment thereof. Moreover, the planning data may serve as a realistic database for automation of an efficient work process during the creation of swaths.

In an embodiment, the control unit is integrated in an agricultural utility vehicle coupled to the rake and controlling the rake. It may be connected, for example, to a system bus (e.g. ISO, CAN) and/or to other function units of the utility vehicle. The data exchange that is possible as a result may aid precise and efficient functionality of the system.

For example, the utility vehicle coupled to the rake is an autonomously drivable or self-propelled vehicle. This further increases the degree of automation in the work involved in creating swaths.

The system can have at least one of the following components, which is connected to the control unit via a data connection:
A user interface for inputting data. As a result, user-based data, for example data coming from the vehicle driver, may be taken into account in a technically simple manner when determining the planning data.
A position detection system (e.g., GPS), which can be arranged on the agricultural utility vehicle.
A data center from which field data representing at least one characteristic of the mown agricultural field can be retrieved. This allows the control unit to efficiently access field data that is relevant for determining the planning data.
A mowing machine for mowing the crop.
A recovery machine for recovering the created swath.
A database with data representing characteristic recovery data of the recovery machine. This helps to supply the control unit with input data relevant for determining the planning data.

The above and other features will become apparent from the following detailed description and accompanying drawings.

### BRIEF DESCRIPTION OF THE DRAWINGS

The disclosure is explained in greater detail below with reference to the appended drawings. Component parts of equivalent or comparable function are identified by the same reference signs in this case. In the drawings:

FIG. 1 shows an illustration in the manner of a block diagram of the system according to the disclosure;

FIG. 2 shows an illustration in the manner of a block diagram of details of the method according to the disclosure;

FIG. 3a shows a schematic detail of a mown agricultural field with a work strategy for creating a swath; and

FIG. 3b shows a schematic detail of a mown agricultural field with a different work strategy for creating a swath.

### DETAILED DESCRIPTION

The embodiments or implementations disclosed in the above drawings and the following detailed description are not intended to be exhaustive or to limit the present disclosure to these embodiments or implementations.

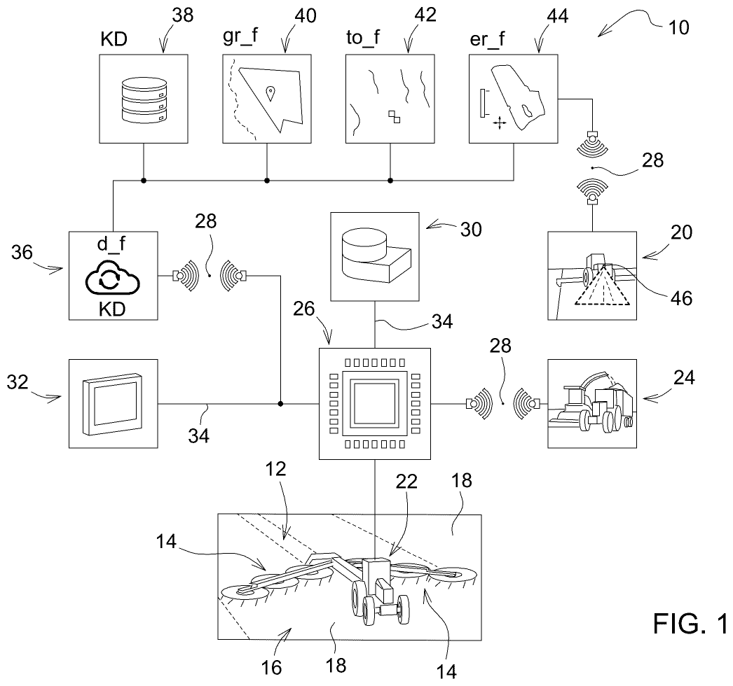

FIG. 1 shows a system 10 for planning a swath 12, which is created by a rake 14 by raking together a crop 18, e.g., forage grass, mown on an agricultural field 16. The crop 18 was previously mown using a mowing machine 20. The rake 14 is arranged on an agricultural utility vehicle 22 in the form of a tractor and is controlled by the utility vehicle 22. The swath 12 or the swaths 12 are collected or recovered by means of a recovery machine 24. The recovery machine 24 can be a single machine or a combination of several machines. FIG. 1 shows a recovery operation using a combination of a forage harvester and a loader wagon.

Various planning data d_plan are generated in a control unit 26 for planning the swath 12. The control unit 26 can be integrated in the utility vehicle 22. The utility vehicle 22 is either controlled by a vehicle driver or is active in an automated manner as an autonomous vehicle on the agricultural field 16.

The utility vehicle 22 and other components of the system 10 are connected to the control unit 26 in various ways via a data connection to perform the planning of the swath 12. The recovery machine 24 thus communicates with the control unit 26 via a wireless data connection 28. A position detection system 30 and a user interface 32 (e.g. keyboard and screen for inputting and/or displaying data) are arranged in or on the utility vehicle 22 and are each connected to the control unit 26 via a wired data connection 34. The control unit 26 is connected to a data center 36 via a further wireless connection 28. The data center may be based on Cloud technology. It may serve as a central data storage device and/or data processing center for various field activities of a farmer or on a farm. The control unit 26 can receive various data via the data center 36. This data may include, for example, specific characteristic recovery data KD of different recovery machines 24 (e.g. forage harvesters, balers, silage wagons) contained in a capacity database 38 or may include field data d_f representing at least one characteristic of the mown agricultural field 16. Examples of this field data d_f are a digital field boundary map 40, a digital topology map 42 and a digital yield map 44.

The yield map 44 can, for example, be generated using the sensor data of a drone or using the sensor data of a suitable sensor 46 on the mowing machine 20. The mowing machine 20 can send the sensor data (optionally in already processed form) via a further wireless data connection 28 to a database containing the digital yield map 44 or to the data center 36. Alternatively, the digital yield map 44 can be provided by another external data source.

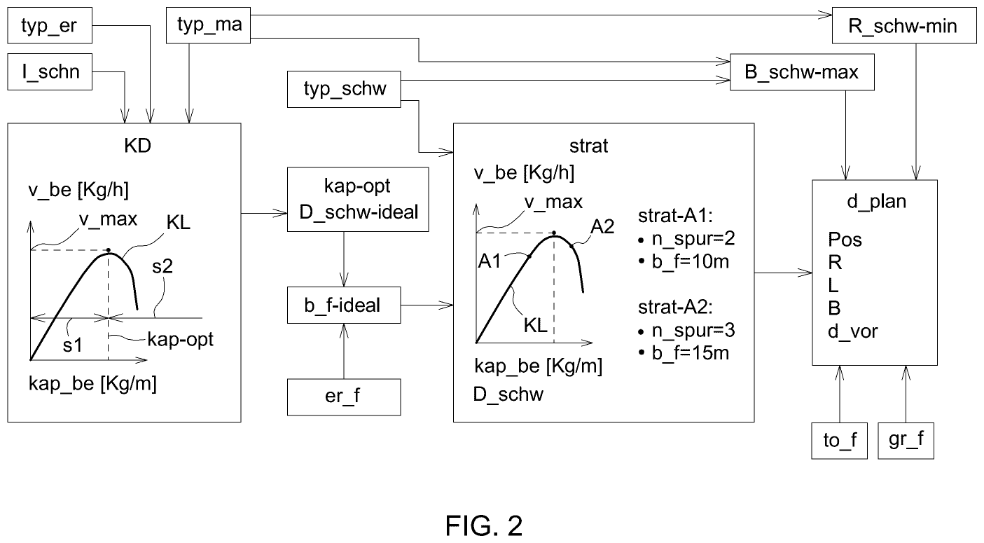

FIG. 2 shows an example of a process sequence for planning the swath 12 to be created. Planning data d_plan of the swath 12 are determined as a function of several planning parameters. As planning parameters, the aforementioned field data d_f of the mown agricultural field 16 are for example used, which comprise a field topology to_f and field boundaries gr_f and er_f of the mown agricultural field 16.

As further planning parameters, a type typ_er of the crop 18, a type typ_schw of the rake 14 planned for the creation of the swath 12, a type typ_ma of the recovery machine 24 planned for the recovery and a cutting length l_schn of the swath material 12 processed during the recovery can be taken into account.

The aforementioned planning parameters can be regarded as input variables for the method or for an algorithm in the control unit 26 for carrying out the method. Various planning parameters or input variables can be used directly to determine the planning data d_plan or can first be used to determine, calculate, ascertain, specify, or define other variables that are used to determine or derive planning data d_plan.

With the aid of the planning data d_plan, a swath 12 can be created on the mown agricultural field 16 according to the plan, taking into account various field data d_f, in such a way that the capacity of the recovery machine 24 used is optimally utilized and the efficiency of the recovery of the swath 12 is improved.

For example, the planning data d_plan contain at least one of the following variables or information: a planned relative position or geoposition Pos of the swath 12 within the agricultural field 16, a swath radius R for a curved swath path, a swath length L, a swath width B or placement width of the swath material 12 and data d_vor of a headland on the agricultural field 16.

In the sequence shown, for example, the field boundaries gr_f and the field topology to_f are used directly to determine the planning data d_plan. In addition, to determine the planning data d_plan, a minimum swath radius R_schw-min is taken into account, which is derived from the planned recovery machine 24 or its type typ_ma. In addition, to determine the planning data d_plan, a maximum swath width B_schw-max is taken into account, which is defined as a function of the type typ_schw of the planned rake 14 and/or the type typ_ma of the planned recovery machine 24.

In addition, the type typ_er of the crop 18, the cutting length l_schn, the type typ_schw of the planned rake 14, the type typ_ma of the recovery machine 24 and the field yield er_f are used to first generate other variables, which are then used to determine the planning data d_plan.

Depending on the cutting length l_schn, the type typ_er of the crop 18 and the type typ_ma of the recovery machine 24, characteristic recovery data KD of the recovery machine 24 are generated and made available for the execution of the method. Alternatively, the characteristic recovery data KD can be provided in the data center 36. As can be seen in FIG. 2, the planning data d_plan can be determined as a function of the characteristic recovery data KD.

For example, the characteristic recovery data KD include a characteristic curve KL, which represents a ratio between the recovery capacity kap_be (in kg/meter) and a recovery speed v_be (in kg/hour) of the recovery machine 24. In a sector s1 of the characteristic curve KL, the driving speed of the recovery machine 24 is approximately constant, while in sector s2 of the characteristic curve KL, the driving speed of the recovery machine 24 must be reduced in order to be able to recover the larger quantity of swath material 12. This reduces the recovery speed v_be and consequently also the efficiency of the recovery.

The characteristic curve KL can be used to determine what is considered to be the optimum recovery capacity kap-opt of the planned recovery machine 24. The maximum of the characteristic curve KL corresponds to a maximum recovery speed v_max, which enables the most efficient recovery of the swath 12. The optimum recovery capacity kap-opt at the maximum of the characteristic curve KL can therefore be defined as the optimum recovery capacity kap_be.

The optimum recovery capacity kap-opt corresponds to an ideal size or dimensioning of the swath 12, which can be physically represented by an ideal swath thickness D_schw-ideal. It can be defined as a mass of the swath material 12 per unit length (for example in kg/m).

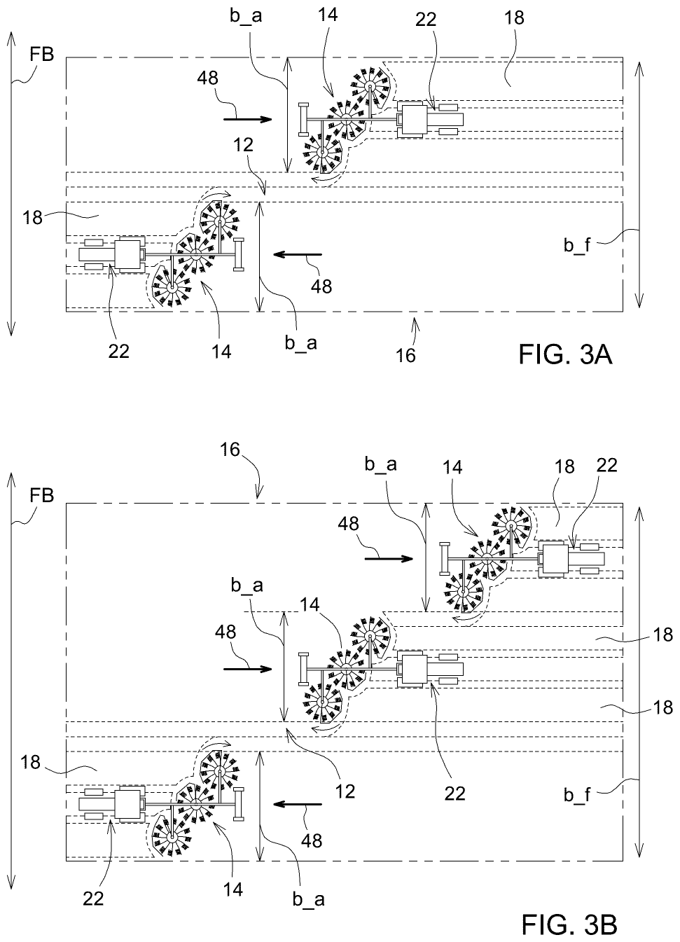

A theoretical ideal field working width b_f-ideal is determined on the basis of the optimum recovery capacity kap-opt (and therefore also an ideal swath thickness D_schw-ideal) and the field yield er_f (e.g., in kg/m²). The ideal field working width b_f-ideal corresponds for example to that field width FB within the mown agricultural field 16 in which the quantity or mass of the mown crop 18 (e.g. per meter along the planned swath path) is exactly sufficient for the optimum recovery capacity kap-opt or the ideal swath thickness D_schw-ideal (FIG. 3a, FIG. 3b). Thus, the ideal field working width b_f-ideal along a field width FB of the mown agricultural field 16 represents an ideal dimensioning for the planned swath 12.

Depending on the ideal field working width b_f-ideal and the type typ_schw of the planned rake 14, a work strategy strat is defined for creating the swath 12. The work strategy strat can be defined in such a way that it comes as close as possible to the theoretically most efficient working conditions according to the ideal field working width b_f-ideal and according to the characteristic curve KL.

Based on this optimization strategy, two possible work strategies strat-A1 and strat-A2 are defined in the example embodiment according to FIG. 2. The selected work strategy strat in turn influences the determination of the planning data d_plan. In the example embodiment, the work strategy strat-A2 can be selected, as it comes closer to the maximum of the characteristic curve KL with a greater recovery performance than the work strategy strat-A1.

In terms of recovery performance, both work strategies strat-A1 and strat-A2 deviate from the theoretically optimal recovery performance kap-opt at the maximum of the characteristic curve KL. Accordingly, the swath thicknesses D_schw achievable with the work strategies strat-A1 and strat-A2 also deviate from the ideal swath thickness D_schw-ideal at the maximum of the characteristic curve KL.

The work strategies strat-A1 and strat-A2 contain specific working variables that are relevant for the creation of the swath 12. For example, a planned number n_spur of tracks 48 (or runs) of the rake 14 and/or a planned field working width b_f within the mown agricultural field 16 are used as working variables for the creation of the swath 12. The planned field working width b_f can correspond to a raking working width b_a of the rake 14 or a multiple, for example an integer multiple, of the raking working width b_a. The work strategies strat-A1 and strat-A2 differ in the values of the working variables.

In the work strategy strat-A1, two tracks 48 are planned to create the swath 12. A field working width b_f=10 meters should be covered within the mown agricultural field 16 in order to create the swath 12.

With the work strategy strat-A2, three tracks 48 are required to create the planned swath 12. A field working width b_f=15 meters should be covered within the mown agricultural field 16 in order to create the swath 12.

FIG. 3a and FIG. 3b show the planned field working width b_f, which for each swath 12 is the product of the planned number n_spur of tracks 48 or the planned number of runs of the rake 14 and its raking working width b_a. Here, the planned field working width b_f is a portion along the field width FB of the mown agricultural field 16.

FIG. 3a shows the implementation of the work strategy strat-A1. There, two tracks 48 and a field working width b_f=10 meters are combined to form a swath 12.

FIG. 3b shows the implementation of the work strategy strat-A2. There, three tracks 48 and a field working width b_f=15 meters are combined to form a swath 12.

When implementing a work strategy strat, in the case of several planned tracks 48, these can either be driven in succession by the same rake 14 or at least partially driven by several simultaneously active rakes 14.

FIG. 3a and FIG. 3b also illustrate the following application examples:

If, based on the conditions according to FIG. 3a and assuming the same field yield er_f, a different type typ_ma of recovery machine with 50% greater recovery capacity kap_be is planned for the recovery of the swath 12, it is more efficient to implement the work strategy strat according to FIG. 3b, as a 50% greater field working width b_f can then be combined to form a correspondingly larger swath 12.

If, based on the conditions according to FIG. 3a and assuming the same type typ_ma of recovery machine 24, a field yield er_f on the agricultural field 16 is detected that is about 30% lower, it is also more efficient to implement the work strategy strat according to FIG. 3b, because the field working width b_f must then be planned 50% larger in order to realize a swath 12 that has the same size as in the conditions according to FIG. 3a.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A method for planning a swath which is created by a rake by raking together a crop mown on an agricultural field, comprising:
determining via a control unit planning data of the swath as a function of at least one of the following planning parameters:
field data representing at least one characteristic of the mown agricultural field,
a type of the crop,
a type of a planned rake,
a type of a planned recovery machine for recovering the created swath, and
a cutting length of the swath material processed during a recovery.

2. The method of claim 1, wherein the field data include one or more of a field topology, field boundaries, and a field yield.

3. The method of claim 1, wherein the planning data are determined as a function of provided characteristic recovery data of the recovery machine.

4. The method of claim 3, wherein the characteristic recovery data are generated and provided as a function of at least one planning parameter.

5. The method of claim 3, wherein the characteristic recovery data represent a ratio between a recovery capacity and a recovery speed of the recovery machine.

6. The method of claim 3, wherein an optimum recovery capacity of the recovery machine is determined from the characteristic recovery data in order to determine the planning data.

7. The method of claim 6, wherein the optimum recovery capacity corresponds to a recovery capacity at a maximum recovery speed of the recovery machine.

8. The method of claim 6, wherein the planning data are determined as a function of a work strategy for creating the swath, wherein the work strategy is defined as a function of at least one planning parameter and/or the optimum recovery capacity and/or the type of the planned rake.

9. The method of claim 8, wherein the work strategy is defined as a function of an ideal field working width, which extends within the mown agricultural field transversely to a track of the rake and represents a dimensioning for the planned swath, which can be determined as a function of the optimum recovery capacity and/or the field yield.

10. The method of claim 8, wherein the work strategy contains at least one working variable for creating the swath, wherein the working variable represents one of a planned number of tracks of the rake for the creation of the swath, or a planned field working width within the mown agricultural field, which corresponds to a raking working width of the rake or a multiple of the raking working width.

11. The method of claim 1, wherein the planning data are determined as a function of a maximum swath width of the swath, wherein the maximum swath width is defined as a function of one or more of the type of the planned rake and the type of the planned recovery machine.

12. A system for planning a swath, comprising:
a rake for creating the swath by raking together a crop mown on an agricultural field; and
a control unit configured to determine planning data of the swath as a function of at least one of the following planning parameters:
field data representing at least one characteristic of the mown agricultural field,
a type of the crop,
a type of a planned rake,
a type of a planned recovery machine for recovering the created swath, and
a cutting length of the swath material processed during a recovery.

13. The system of claim 12, wherein the control unit is integrated in an agricultural utility vehicle coupled to the rake.

14. The system of claim 13, wherein the agricultural utility vehicle is autonomously drivable.

15. The system of claim 12, wherein at least one of the following components is connected to the control unit via a data connection:
a user interface for inputting data,
a position detection system,
a data center with field data representing at least one characteristic of the mown agricultural field,
a mowing machine for mowing the crop,
a recovery machine for recovering the swath, and
a database with data representing at least characteristic recovery data of the recovery machine.
